(19) United States
(12) Patent Application Publication
(10) Pub. No.: US 2007/0167552 A1
(43) Pub. Date: Jul. 19, 2007

(54) Polyamide moulding materials for the production of moulded articles having reduced surface carbonization

(76) Inventors: Georg Stoeppelmann, Bonaduz (CH); Ralph Ketti, Paspels (CH); Botho Hoffmann, Domat/Ems (CH); Martina Ebert, Domat/Ems (CH); Manfred Hewel, Domat/Ems (CH)

Correspondence Address: BELL, BOYD & LLOYD, LLP, P.O. Box 1135, CHICAGO, IL, 60690, US

(21) Appl. No.: 11/583,437

(22) Filed: Oct. 17, 2006

Related U.S. Application Data
(63) Continuation-in-part of application No. 10/646,952, filed on Aug. 22, 2003.

(30) Foreign Application Priority Data
Aug. 27, 2002 (DE) 10239326.5
Oct. 17, 2005 (EP) 05022595.2

(51) Int. Cl. C08K 9/04

(52) U.S. Cl. 524/445

(57) ABSTRACT

Moulded articles having reduced surface carbonization and longer retention of the mechanical properties and methods of producing same are presented. In an embodiment, the moulded article comprises polyamides with nanofillers, which can be produced by means of injection moulding or extrusion, in particular by extrusion blow moulding, coextrusion blow moulding or sequential blow moulding with and without 3D hose manipulation. For example, the polyamide moulding materials for the production of moulded articles have reduced surface carbonization in the moulded articles in subsequent long-term use at elevated temperatures.

### PRIORITY CLAIMS

This application is a continuation-in-part of U.S. patent application Ser. No. 10/646,952 filed on Aug. 22, 2003, which claims priority to German Application No. 102 39 326.5 filed on Aug. 27, 2002. This application also claims priority to European Patent Application No. 05 022 595.2 filed on Oct. 17, 2005, the entire disclosures of which are hereby incorporated.

### BACKGROUND

The present invention relates generally to polymer compositions. More specifically, the present invention relates to polyamide moulding materials with nano-scale fillers for the production of moulded articles.

Conventional metallic materials in motor vehicles are being more and more frequently replaced by lighter materials such as, for example, plastics, as part of weight reduction. In order to achieve a similar level in mechanical properties, the plastics in technical components which are exposed to mechanical or thermal loads must be strengthened.

Particular applications in the automotive sector and in particular in the engine space also require high stability of the plastic materials used in terms of their mechanical properties with respect to the temperatures occurring. These requirements are also long-term requirements over the entire time of use of a vehicle. For example, the plastic materials should be operational stable at temperatures of more than 135° C. and over periods of more than 500 hours or longer, for example, more than 3000 hours. However, the plastic materials currently available often exhibit a substantial decline both in their mechanical properties and their stability to atmospheric oxidation.

### SUMMARY

In an embodiment, the present invention provides a method of producing a moulded article. For example, the method comprises providing at least one thermoplastic polymer such as, for example, polyamides, polyesters, polyetheresters, polyesteramides and combinations thereof and combining the thermoplastic polymer with at least one nano-scale filler that is less than 500 nm in at least one dimension to produce a moulding material, wherein the nano-scale filler ranges in an amount from about 0.5 to about 15% by weight of the total weight of the moulding material; and forming the moulded article from the moulding material. The molded article has a longer retention of mechanical properties and a reduced surface carbonization when the moulded article is used at a temperature above 135° C. in comparison with a moulded article comprising the same polyamide that contains no nano-scale fillers. Additional additives can be added to moulding material to produce the molded article.

In an embodiment, the moulded article has a reduced surface carbonization when used at a temperature above 150° C. (e.g. air) for a duration of more than 500 hours. Preferably, the moulded article has a reduced surface carbonization when used at a temperature above 200° C. The moulded article can have a reduced surface carbonization when used at a temperature above 150° C. (e.g. air) for a duration of more than 1000 hours or more than 3000 hours.

In an embodiment, the moulding material can comprise up to 65% by weight, based on the total weight of the moulding material of reinforcing materials (except for nano-scale layered silicates) such as, for example, fibrous filler materials. Preferably, the moulding material can comprise up to 30% by weight, based on the total weight of the moulding material of reinforcing materials

In an embodiment, the moulding material can comprise impact modifiers in amount from about 1 to about 25% by weight of the total weight of the moulding materials. Preferably, the moulding material can comprise impact modifiers in amount from about 3 to about 12% by weight of the total weight of the moulding materials.

In an embodiment, the method can further comprise combining the moulding material with a second moulding material comprising a second polyamide polymer. The tensile moduli of elasticity of the two moulding materials differ by at least a factor of 1.2.

In an embodiment, the moulding material can comprise from about 1 to 80% by weight of a rubber-elastic polymer (e.g. a core-shell polymer) and from about 20 to 99% by weight of a polyamide.

In an embodiment, the polyamide can comprise a viscosity of 2.3 to 4.0, measured on a 1.0% by weight solution in sulphuric acid at 20° C. Preferably, the polyamide can comprise a viscosity of 2.6 to 3.8, measured on a 1.0% by weight solution in sulphuric acid at 20° C.

In an embodiment, the moulding material can comprise from about 2% to about 10% by weight of the nano-scale filler and up to 30% by weight of a fibrous filler material based on the total weight of the moulding material.

In an embodiment, the nano-scale filler can be, for example, bentonite, smectite, montmorillonite, saponite, beidellite, nontronite, hectorite, stevensite, vermiculite, illite, pyrosite, kaolin, serpentine, silicone, silica, silsesquioxane, double hydroxides and combinations thereof.

In an embodiment, the filler has been treated with adhesion promoters and the adhesion promoter is present in an amount up to about 10% by weight of the moulding material.

In an embodiment, the polyamide can be a polymer of monomers or monomer mixtures such as, for example, aliphatic lactams having 4 to 44 carbon atoms, ω-aminocarboxylic acids having 4 to 44 carbon atoms (preferably 4 to 18 carbon atoms), polycondensates obtained from monomers comprising at least one diamine and at least one dicarboxylic acid and combinations thereof.

In an embodiment, the diamine can be, for example, aliphatic diamines having 4 to 12 C atoms, cycloaliphatic diamines having 7 to 22 C atoms, the aromatic diamines having 6 to 22 C atoms and combinations thereof.

In an embodiment, the dicarboxylic acid can be, for example, aliphatic dicarboxylic acids having 4 to 12 C atoms, cycloaliphatic dicarboxylic acids having 8 to 24 C atoms, aromatic dicarboxylic acids having 8 to 20 C atoms and combinations thereof.

In an embodiment, the polyamide can comprise an additional building block such as, for example, diols, polyethers having hydroxyl terminal groups, polyethers having amino terminal groups and combinations thereof.

In an embodiment, the lactams and the co-aminocarboxylic acids can be, for example, ∈-aminocaproic acid, 11-aminoundecanoic acid, 12-aminododecanoic acid, ∈-caprolactam, enantholactam, ω-laurolactam and combinations thereof.

In an embodiment, the diamine can be, for example, 2,2,4- or 2,4,4-trimethylhexamethylenediamine, cyclohexyldimethyleneamine, bis(p-aminocyclo-hexylmethane, m- or p-xylylenediamine, 1,4-diaminobutane, 1,6-diaminohexane, methylpentamethylenediamine, nonanediamine, methyloctamethylenediamine, 1,10-diaminodecane, 1,12-diaminododecane, cyclohexyldimethyleneamine and combinations thereof

In an embodiment, the dicarboxylic acid can be, for example, succinic acid, glutaric acid, adipic acid, suberic acid, pimelic acid, suberic acid, azelaic acid, sebacic acid, dodecanedicarboxylic acid, cyclohexanedicarboxylic acid, terephthalic acid, isophthalic acid, naphthalenedicarboxylic acid and combinations thereof.

In an embodiment, the polyamide can be a homopolyamide or copolyamide such as, for example, polyamide 6, polyamide 46, polyamide 66, polyamide 11, polyamide 12, polyamide 1212, polyamide 1012, polyamide 610, polyamide 612, polyamide 69, polyamide 99, polyamide 9T, polyamide 12T, polyamide 10T, polyamide 12I, polyamide 12T, polyamide 12T/12, polyamide 10T/12, polyamide 12T/106, polyamide 10T/106, polyamide 6/66, polyamide 6/612, polyamide 6/66/610, polyamide 6/66/12, polyamide 6/6T, PA 6T/6, PA 6T/12, polyamide 6T/6I, polyamide 6I/6T, polyamide 6/6I, polyamide 6T/66, polyamide 6T/66/12, polyamide 12/MACMI, polyamide 66/6I/6T, polyamide MXD6/6, polyesteramides, polyetheresteramides, polyetheramides and combinations thereof (including blends and alloys of these polymers).

In an embodiment, the method can further comprise adding to the moulding material a polymer such as, for example, polyesters, polycarbonates, polyolefins, polyethylenevinyl alcohols, styrene polymers, fluoropolymers, polyphenylene sulphide, polyphenylene oxide and combinations thereof. For example, the method can comprise adding these polymer in an amount of up to 50% by weight, in particular up to 30% by weight.

In an embodiment, the method can further comprise adding to the moulding material an additive such as, for example, UV and heat stabilizers, antioxidants, pigments, dyes, nucleating agents, crystallization accelerators, crystallization retardants, flow improvers, lubricants, mould release agents, plasticizers, flame retardants, agents that improve the electrical conductivity and combinations thereof.

In an embodiment, the method can further comprise adding glass fibres to the moulding material. For example, the glass fibres can be E-glass fibres.

In an embodiment, the method can further comprise adding to the moulding material an impact modifier such as, for example, ethylene-propylene rubbers, ethylene-propylene-diene rubbers, acrylate rubbers, styrene-containing elastomers, nitrile rubbers, silicone rubbers, ethylene vinyl acetate, microgels and combinations thereof.

In an embodiment, the moulded article can be formed by a process such as, for example, injection moulding, extrusion moulding, extrusion blow moulding and combinations thereof (with or without 3D blow moulding).

In an embodiment, the extrusion blow moulded article can comprise an air conducting article for motor vehicles.

In an embodiment, the air conducting article can comprise a charge air pipe for turbochargers in an automotive sector.

In an embodiment, the moulding material can comprise a highly viscous extrusion blow moulding material.

In another embodiment, the present invention provides a moulding material suitable for an extrusion blow moulding process comprising: (a) at least one thermoplastic polymer such as, for example, polyamides, polyesters, polyetheresters, polyesteramides and combinations thereof, (b) at least one nano-scale filler having a particle size of less than 500 nm in at least one dimension, the nano-scale filler in an amount of 0.5 to 15% by weight of the total weight of the moulding material, (c) at least one fibrous filler material in amounts up to about 0 to about 65% by weight of the total weight of the moulding material, preferably about 5 to about 30% by weight, and (d) at least one impact modifier in an amount from about 0 to about 25% by weight, preferably about 3 to about 12% by weight, of the total weight of the moulding material, wherein a molded article produced from said moulding material has a longer retention of mechanical properties (elongation at break and/or ultimate tensile strength) and a reduced surface carbonization when the moulded article is used at a temperature above 135° C. in comparison with a moulded article comprising the same thermoplastic polymer that contains no nano-scale fillers.

In an embodiment, the moulding material comprises a melt strength at least 30% higher than the same moulding materials which, instead of the nano-scale fillers, contain only customary mineral fillers such as, for example, amorphous silicic acid, kaolin, magnesium carbonate, mica, talc and feldspar. The inventors have moreover gained the experimental knowledge, that customary mineral fillers have nearly no influence on the melt strength. This means that alternatively the same moulding material, but without any mineral fillers, can be used by way of comparison of the melt strength, with the same numerical result. For example for blends of polyamide 6 and polyamide 66, the comparison material was a blend of 42% by weight of polyamide 6 and 42% by weight of polyamide 66, 6% by weight of impact modifier and 10% by weight of glass fibres, according to comparative example C4 in Table 2.

In an embodiment, the moulding material comprises a second moulding material comprising a second thermoplastic polymer such as, for example, polyamides, polyesters, polyetheresters, polyesteramides and combinations thereof, wherein the tensile moduli of elasticity of the two moulding materials differ by at least a factor of 1.2.

In an embodiment, the second moulding material is composed of 0 to 80% by weight of a rubber-elastic polymer, in particular of a core-shell polymer, and 100 to 20% by weight of a polyamide.

In an embodiment, the polyamides for the moulding materials have a relative viscosity, measured on a 1.0 percent by weight solution in sulphuric acid at 20° C., of 2.3 to 4.0, in particular of 2.6 to 3.8.

In an embodiment, nano-scale fillers in an amount of 2-10% by weight and, as further additives, fibrous filler materials in an amount of 0-30% by weight, based in each case on the total weight of the moulding material, are present in the moulding materials.

In an embodiment, the nano-scale fillers can be, for example, the natural and synthetic layered silicates, in particular, bentonite, smectite, montmorillonite, saponite, beidellite, nontronite, hectorite, stevensite, vermiculite, illites and pyrosite of the group consisting of the kaolin and serpentine minerals or are double hydroxides or those fillers based on silicones, silica or silsesquioxanes, montmorillonite, which are particularly preferred.

In an embodiment, the mineral has been treated with adhesion promoters and the adhesion promoter is present in an amount of up to 10% by weight in the moulding material.

In an embodiment, the polyamides are polymers of monomers or monomer mixtures selected from aliphatic lactams or ω-aminocarboxylic acids having 4 to 44 carbon atoms, preferably 4 to 18 carbon atoms or are polycondensates obtainable from monomers comprising at least one diamine such as, for example, aliphatic diamines having 4 to 12 C atoms, the cycloaliphatic diamines having 7 to 22 C atoms and the aromatic diamines having 6 to 22 C atoms in combination with at least one dicarboxylic acid such as, for example, aliphatic dicarboxylic acids having 4 to 12 C atoms, cycloaliphatic dicarboxylic acids having 8 to 24 C atoms and aromatic dicarboxylic acids having 8 to 20 C atoms, blends of the abovementioned polymers and/or polycondensates or copolyamides of any desired combinations of said monomers and additional building blocks such as, for example, diols, polyethers having hydroxyl terminal groups and polyethers having amino terminal groups also being suitable.

In an embodiment, the co-aminocarboxylic acids and the lactams can be, for example, ∈-aminocaproic acid, 11-aminoundecanoic acid, 12-aminododecanoic acid, ∈-caprolactam, enantholactam, ω-laurolactam and combinations thereof.

In an embodiment, the diamines can be, for example, 2,2,4- or 2,4,4-trimethylhexamethylenediamine, cyclohexyldimethyleneamine, bis(p-aminocyclo-hexyl)methane, m- or p-xylylenediamine, 1,4-diaminobutane, 1,6-diaminohexane, methylpentamethylenediamine, nonanediamine, methyloctamethylenediamine, 1,10-diaminodecane, 1,1 2-diaminododecane and cyclohexyldimethyleneamine, and the dicarboxylic acids can be, for example, succinic acid, glutaric acid, adipic acid, suberic acid, pimelic acid, suberic acid, azelaic acid, sebacic acid, dodecanedicarboxylic acid, cyclohexanedicarboxylic acid, terephthalic acid, isophthalic acid, naphthalenedicarboxylic acid and combinations thereof.

In an embodiment, the polyamides are homopolyamides or copolyamides such as, for example, polyamide 6, polyamide 46, polyamide 66, polyamide 11, polyamide 12, polyamide 1212, polyamide 1012, polyamide 610, polyamide 612, polyamide 69, polyamide 99, polyamide 9T, polyamide 12T, polyamide 10T, polyamide 12I, polyamide 12T, polyamide 12T/12, polyamide 1OT/12, polyamide 12T/10 6, polyamide 10T/10 6, polyamide 6/66, polyamide 6/612, polyamide 6/66/610, polyamide 6/66/12, polyamide 6/6T, PA 6T/6, PA 6T/12, polyamide 6T/61, polyamide 61/6T, polyamide 6/61, polyamide 6T/66, polyamide 6T/66/12, polyamide 12/MACMI, polyamide 66/61/6T, polyamide MXD6/6, polyesteramides, polyetheresteramides, polyetheramides or mixtures, blends or alloys thereof.

In an embodiment, the second moulding material is present in amounts of up to 50% by weight, in particular of up to 30% by weight, and a component such as, for example, polyesters, polycarbonates, polyolefins, polyethylenevinyl alcohols, styrene polymers, fluoropolymers, PPS and PPO are added to the moulding materials.

In an embodiment, the further additives such as, for example, UV and heat stabilizers, the antioxidants, the pigments, dyes, nucleating agents, crystallization accelerators, crystallization retardants, flow improvers, lubricants, mould release agents, plasticizers, flame retardants and agents which improve the electrical conductivity are added to the moulding materials.

In an embodiment, the further additives or the fibrous filler materials are glass fibres, in particular E-glass fibres.

In an embodiment, the further additives are impact modifiers such as, for example, polymers based on polyolefins which may be functionalized, in particular ethylene-propylene rubber (EPM, EPR), ethylene-propylene-diene rubbers (EPDM), acrylate rubbers, styrene-containing elastomers, e.g. SEBS, SBS or SEPS; and nitrile rubbers (NBR, H-NBR), silicone rubbers, EVA or microgels and mixtures of different impact modifiers.

In an alternative embodiment, the present invention provides a moulded article comprising a moulding material comprising: (a) at least one thermoplastic polymer such as, for example, polyamides, polyesters, polyetheresters, polyesteramides and combinations thereof; (b) at least one nano-scale filler having a particle size of less than 500 nm in at least one dimension, the nano-scale filler in an amount of 0.5 to 15% by weight of the total weight of the moulding material, (c) at least one fibrous filler material in amounts up to 65% by weight of the total weight of the moulding material, preferably about 5 to about 30% by weight, and (d) at least one modifier in an amount from about 0 to about 25% by weight of the total weight of the moulding material, wherein the molded article has a longer retention of mechanical properties (elongation at break and/or ultimate tensile strength) and a reduced surface carbonization when the moulded article is used at a temperature above 135° C. in comparison with a moulded article comprising the same thermoplastic polymer that contains no nano-scale fillers.

In an embodiment, the moulding material comprises a melt strength at least 30% higher than the same moulding materials which, instead of the nano-scale fillers, contain only customary mineral fillers such as, for example, amorphous silicic acid, kaolin, magnesium carbonate, mica, talc and feldspar. The inventors have moreover gained the experimental knowledge, that customary mineral fillers have nearly no influence on the melt strength. This means that alternatively the same moulding material, but without any mineral fillers, can be used by way of comparison of the melt strength, with the same numerical result. For example for blends of polyamide 6 and polyamide 66, the comparison material was a blend of 42% by weight of polyamide 6 and 42% by weight of polyamide 66, 6% by weight of impact modifier and 10% by weight of glass fibres, according to comparative example C4 in Table 2.

In an embodiment, the moulded article comprises a second moulding material comprising a second polyamide polymer, wherein the tensile moduli of elasticity of the two moulding materials differ by at least a factor of 1.2.

In an embodiment, the molded article comprises an extrusion blow moulded air conducting article comprising alternating sequential rigid and flexible segments of the moulding material over its entire length.

In an embodiment, the moulded article comprises an extrusion blow moulded air conducting air pipe for turbochargers in an automotive sector.

In an embodiment, the conducting air pipe comprises at least one polymer layer and closed, geometrical outer structures that are a distance apart in the pipe axis direction and define a corrugation on the pipe casing in at least one radially angular region in the axial longitudinal direction in succession, the closed, geometrical outer structures being formed so that two regions of the pipe surface that are approximately opposite one another are free of corrugation extend in the longitudinal direction, the outer contours forming the corrugation having a shape such as for example, ellipses, ovals, slots and combinations thereof in the radial section.

In an embodiment, the conducting air pipe comprises at least partly wavy regions.

In an embodiment, the moulded article is produced by a process such as, for example, extrusion blow moulding, co-extrusion blow moulding, sequential blow moulding and combinations thereof. For example, these processes can be with or without 3D blow moulding methods.

Additional features and advantages are described herein, and will be apparent from, the following Detailed Description and the figures.

### BRIEF DESCRIPTION OF THE FIGURES

FIG. 1 is a graph illustrating a comparison of Example 8 with the variant C6 showing their mechanical properties in the case of long-term storage at elevated temperature measured in terms of relative elongation at break (EB).

FIG. 2 is a graph illustrating a comparison of Example 8 with the variant C6 showing their mechanical properties in the case of long-term storage at elevated temperature measured in terms of the relative ultimate tensile strength (TS).

FIG. 3 illustrates a method in which the melt strength is assessed by using a hose extruded continuously via an angle head.

FIG. 4 illustrates the tensile test bars shown in pairs. The light one is a tensile test bar prior to the storage at elevated temperature and the black one is a tensile test bar of the same composition after storage for 408 hours at 230° C.

### DETAILED DESCRIPTION

The present invention is directed to polyamide moulding materials comprising nano-scale fillers for the production of moulded articles. Especially during later long-term use at elevated temperatures, for example, the polyamide moulded articles produced retain their mechanical properties for longer duration and show substantially reduced surface carbonization.

In an embodiment, the moulded articles may be moulded articles of any kind as understood by the skilled artisan. These are generally injection-moulded articles, extruded articles or extrusion blow moulded articles in all variants. A preferred example of the latter relates to air conducting channels for air supply systems of motor vehicles, in particular extrusion blow moulded charge air pipes for turbochargers in the automotive sector.

As used herein, the term “polyamides” means all homopolyamides and copolyamides (the latter including polyamide elastomers such as, for example, polyesteramides, polyetheresteramides and polyetheramides) and mixtures (e.g. blends) of homopolyamides and/or copolyamides.

In an embodiment, the polyamide moulding materials comprise at least 30% by weight of polyamide, preferably at least 50% by weight of polyamide. However, it is also possible for a copolymer having polyamide building blocks which contain polyester, polyether, polysiloxane, polycarbonate, polyacrylate, polymethacrylate or polyolefin segments to be used in addition to said polyamides or alone in the moulding materials. Such a copolymer contains at least 20% by weight of polyamide building blocks. In another embodiment, this copolyamide contains at least 30% by weight of polyamide building blocks, particularly preferably at least 40% by weight of polyamide building blocks.

The use of heat-stabilized polyamide for applications to the automotive sector, in particular in the engine space, is important. Polyamides such as, for example, polyamide 6 and polyamide 66, are suitable here. However, these polyamides are often modified, i.e. heat-stabilized or elastomer-modified, and they thus become particularly impact-resistant or stable to hydrolysis or exhibit reduced heat aging (R. Zimnohl, Kunststoffe 88 (1988) 5, pages 96-694, Carl Hanser Verlag, Munich).

The processing of polyamide moulding materials to give moulded articles is usually effected by means of injection moulding machines, extrusion units or blow moulding units. Special processes such as 2-component injection moulding, injection embossing, etc. or 1-layer and multilayer extrusion (co-extrusion), are of course also known to the person skilled in the art. An overview in this context is given, for example, by the book by W. Michaeli: “Einführung in die Kunststoffverarbeitung [Introduction to plastics processing]”, 4th edition, Carl Hanser Verlag, Munich 1999.

Moulded articles may be, inter alia, in the form of hollow bodies. The production of hollow bodies from thermoplastics is carried out today on a large scale by extrusion blow moulding methods or the special methods associated with this method. In addition to the customary hollow bodies, the range of products produced can comprise a multitude of technical moulded articles, e.g. for applications in the field of the automobile industry such as fuel tanks, air conducting channels, intake pipes or parts of intake pipes or suction modules, etc. To an increased extent, any imaginable form of pipes or hoses for pressurized or pressureless media can be produced using the recent 3D blow moulding methods such as, for example, 3D hose manipulation, 3D vacuum blow method.

The extrusion blow moulding principle is that an extruded melt hose is received by a generally two-part, cooled hollow mould and blown up with the aid of compressed air to give the finished hollow body. In most cases, the hose produced in the annular die gap of a cross injection head emerges vertically downwards. As soon as this parison (e.g. hollow tube to be formed into a hollow object by blow molding) has reached the required length, the mould halves are closed. The cutting edges of the moulds grip the hose, weld it and at the same time squeeze the residues projecting up and down.

From the process-technical point of view, the following are general standards for the raw materials used in blow moulding:

High melt tenacity or strength (high viscosity), respectively: This standard results from the necessary hose stability, also referred to below as melt strength. Even with the use of melt storage and low processing temperatures, longer parisons can be produced by a reliable production process and reproducibly only from products having correspondingly high hose stability. However, there is the problem that the parison extends under the weight of the extruded hose itself. Apart from the production of very small blow moulded bodies, unmodified polyamides having medium and normal melt viscosity, i.e. products having a relative viscosity (ηᵣₑₗ<2.3 (measured on a 1% by weight solution of polyamide 6 in H₂SO₄ at 20° C.) are therefore ruled out for the extrusion blow moulding method. When blowing hollow bodies having a volume exceeding about 0.5 1, it is necessary to use extremely high-viscosity formulations (ηᵣₑₗ>4.0; measured on a 1% by weight solution of polyamide 6 in H₂SO₄ at 20° C.). Only the high molecular weight, the branched or the partly crosslinked polyamides are therefore suitable as raw materials for the blow moulding method.

High thermal stability: This standard results from the very long residence time of the material at high temperatures in the parison head and the fact that the parison surface is exposed to the oxidative attack by atmospheric oxygen during the extrusion and blow-up process, and later especially during the use of the moulded articles at elevated temperature, for example, under the bonnet in automobiles.

Good melt extensibility: This substantially determines the achievable blow-up ratio and the wall thickness distribution.

For certain applications, moulded articles which have material properties differing from zone to zone may also be required. Fields of use for moulded articles having alternating property combinations are, for example, automotive construction and mechanical engineering. Thus, damping and thermal expansion segments can be housed in a pipe, for example, in an air charge pipe, for a motor vehicle turbo diesel engine. These air charge pipes can be produced by 3D extrusion and subsequent blow moulding. Blow moulded parts having flexible end zones and a rigid middle part can be produced. Such air charge pipes or air conducting pipes require a flexible/rigid combination for good mounting and sealing of the ends on the one hand and sufficient stability to reduced pressure and excess pressure in the middle part on the other hand.

Furthermore, air charge pipes for turbocharged engines should meet high requirements with regard to the temperature of continuous use. To date, metal pipes (aluminium) have been used here. There is therefore a demand for polyamide moulding materials having a high thermal and mechanical load capacity, which can be used for the production of plastic air charge pipes. The stability of the plastics used to thermal oxidation is an important point for applications in the engine space. In particular, the surface of the moulded polyamide articles should not carbonize at relatively high temperatures of use (as a rule 135° C. to more than 200° C.; duration of use of more than 500 hours).

WO 2004/099316 A1 (Domo Caproleuna GmbH) describes polymer nanocomposite blends comprising at least two polymers and nanodisperse delaminated layered silicates. The polymer nanocomposite blends contain polyamide and polypropylene. A disadvantage of the use of these moulding materials comprising polyamide and polypropylene for the production of moulded articles is the comparatively low heat distortion temperature.

WO 02/079301 A2 (Eikos, Inc.) describes polymer nanocomposite materials having high thermal stability. The improved thermal stability is achieved by treating the phyllosilicates with a nitrile-containing monomer, preferably phthalonitrile.

U.S. Pat. No. 6,632,862 (Amcol) describes nanocomposite concentrates, polyolefins such as polypropylene being used as preferred polymers. Less degradation of the polymer during production is said to be achieved by the masterbatch process.

WO 2005/003224 (Imerys Minerals Ltd.) describes flameproof moulding materials comprising clay minerals. The flame resistance of moulded articles of corresponding moulding materials can be increased by adding an amine-modified clay mineral.

WO 2005/056913 A1 (Huntsman) describes polymeric moulding materials comprising a filler expandable by the action of heat, for example, graphite and a nanofiller such as, for example, phyllosilicates.

WO 2004/039916 A1 (Commonwealth Scientific and Industrial Research Organization) describes flameproofed moulding materials.

U.S. 6,548,587 B1 claims one or more polyamide polymers or compolymers comprising poly(m-xylylene adipamide) or poly(m-xylylene adipamide-co-isophthalamide) with layered clay materials, e.g. for bottles with improved gas barrier properties. Such polyamides with m-xylylene moieties are amorphous.

WO 01/85835 A1 (Bayer AG) describes polyamide moulding materials comprising reinforcing materials and nano-scale layered silicates, which have improved heat aging behavior. Here, heat aging means the behavior with respect to liquid cooling media, in particular a glycol/water mixture at 130° C. (see WO 01/85835 A1 , page 1, lines 22-25, and page 11, lines 21-25), the impact strength having been investigated.

EP 1 359 196 A1 (Rehau AG & Co.) describes polyamide compositions which have been reinforced with layered silicates and have a high heat distortion temperature in combination with high rigidity and high impact strength. The moulding materials are used for the production of moulded articles or semi-finished products for the electrical industry.

EP 1 198 520 B1 (Solvay Advanced Polymers, LLC) describes methods for reducing the formation of mould deposits during the moulding of polyamides and compositions thereof.

EP 1 245 417 A2 (Behr GmbH) states that the thermal requirements with regard to heat transfer media comprising polyamide can be achieved by an antioxidation coating of an antioxidation paint. An additional treatment step of the finished article is required for this purpose (surface coating).

It is therefore an object of the present invention to provide improved plastic materials as a substitute for other materials for certain intended uses, for example, in the engine space of motor vehicles, which have a good heat distortion temperature, heat aging stability to atmospheric oxidation, high temperature of continuous use, high chemical resistance even at temperatures above 135° C. and also have a balanced mechanical property profile with regard to the mechanical properties after prolonged use or exhibit retention of the mechanical properties even at high temperatures of use and after long durations of use.

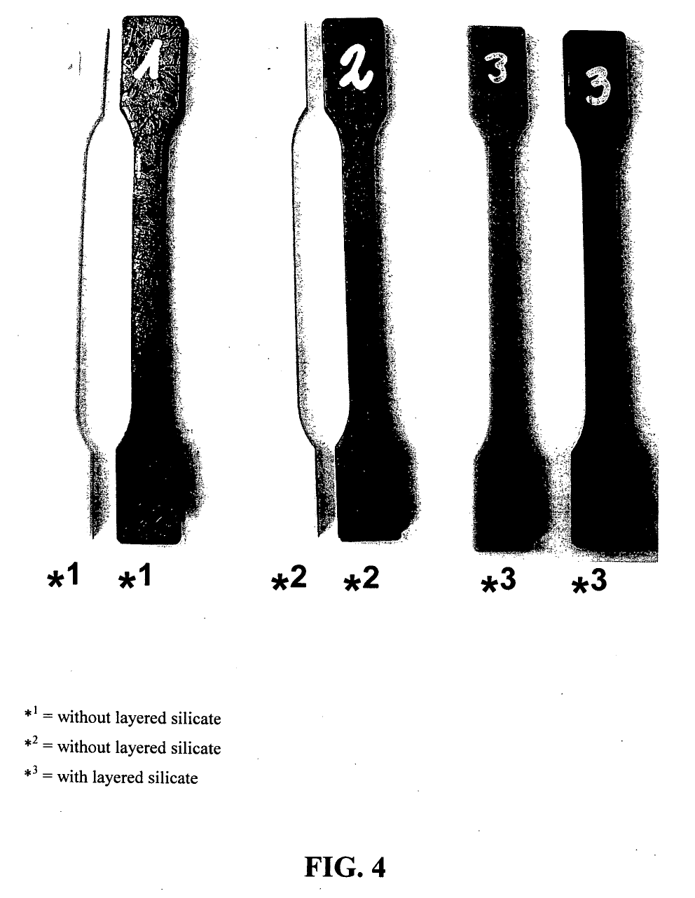

According to an embodiment of the present invention, it has surprisingly been found that, as a result of the incorporation of nano-scale fillers into polyamide moulding materials (i.e. fillers which are less than 500 nm in at least one dimension), longer retention of the mechanical properties and substantially reduced surface carbonization during use at temperatures above 135° C. in air occur in the case of the corresponding moulded articles produced from these moulding materials. At these temperatures, i.e. at temperatures above 135° C., in particular at temperatures above 150° C., preferably above 200° C., the incorporated nanofillers evidently result in a surface passivation with respect to atmospheric oxidation, which is clearly displayed on prolonged use, i.e. especially when the finished articles are used in a hot environment. In the context in an embodiment of the present invention, longer retention of the mechanical properties (elongation at break and/or ultimate tensile strength) means a period of more than 500 hours, preferably of more than 1000 hours, more preferably of more than 3000 hours, and therefore relates to long-term requirements over the entire time of use of a vehicle. As a result of surface passivation and an associated lower proportion of microcracks, the endurance under dynamic load can be improved (see FIG. 4, bar no. 3).

It was surprisingly found that test specimens which are produced as moulding materials according to various embodiments of the present invention show substantially less or virtually no carbonization on the surface on storage at elevated temperatures or heat aging in comparison with articles comprising the same polyamides which contain no nanofillers. It was found that, in the case of the moulded articles according to embodiments of the present invention, the surface does not exhibit the formation of black residues of carbon which are otherwise found on storage of the articles at above 135° C. after more than 500 hours due to degradation by thermal oxidation. By surface passivation and the associated smaller proportion of microcracks, the endurance under dynamic load can be improved (FIG. 4, bar no. 3)

This is all the more surprising in view of the circumstance that the person skilled in the art knew from the nanocomposites conference in 2005 (see lecture by Dr. H. Wermter: “How to improve long-term performance of nanocomposites”, Brussels, Belgium, Mar. 9th-10th, 2005) or WO 2004/063268 A1 that the addition of nanofillers adversely affects the polymer stability.

The degradation process due to thermal oxidation on the surface is greatly suppressed by the formulations used according to embodiments of the present invention. On storage at elevated temperatures, the mechanical properties such as, for example, the elongation at break and/or ultimate tensile strength (measured on 4 mm bars according to ISO 527) therefore also decrease to a substantially lesser extent and are maintained for a longer time. The inventor has found that this discovery applies generally to an embodiment of the polyamide moulding materials disclosed herein. The upper limit of the temperature range for use is limited in principle only by the melting point of the corresponding polyamide.

The present invention therefore relates to a novel use of moulding materials based on thermoplastic polymers such as, for example, polyamides containing nano-scale fillers which are less than 500 nm in at least one dimension in an amount of 0.5 to 15% by weight, based on the total weight of the moulding material, and optionally further additives, for the production of moulded articles having a longer retention of the mechanical properties and having substantially reduced surface carbonization during use of the moulded articles at the prevailing temperatures of use (air) of above 135° C. in comparison with moulded articles comprising the same polyamides which contain no nano-scale fillers.

In an alternative embodiment, the moulding materials can comprise further additives such as, for example, reinforcing materials (except for nano-scale layered silicates) in particular fibrous filler materials in amounts of up to 65% by weight, preferably up to 30% by weight.

The polyamide moulding materials used according to embodiments of the present invention are in particular highly viscous, i.e. they have a relative viscosity, measured on a 1.0% by weight solution in sulphuric acid at 20° C., of 2.3 to 4.0, in particular 2.6 to 3.8.

The moulding materials according to embodiments of the present invention that are based on thermoplastic polymers such as, for example, polyamides containing nano-scale fillers in an amount of 0.5 to 15% by weight, in particular an amount of 2 to 10% by weight, more preferably in an amount of 2 to 7% by weight, based on the total weight of the moulding material, and optionally further customary additives known to the person skilled in the art.

The processing of the moulding materials according to embodiments of the present invention to give moulded articles is usually effected by means of injection moulding machines or extrusion and blow moulding units. Preferred moulded articles are therefore injection moulded articles and extruded articles. Special extruded articles are air-conducting articles which as a rule are produced by extrusion blow moulding.

If the moulding materials used according to embodiments of the present invention are used for extrusion blow moulding, they preferably have a melt strength which is at least 30% higher than the same moulding materials which, instead of the nano-scale fillers, contain only customary mineral fillers such as, for example, amorphous silicic acid, kaolin, magnesium carbonate, mica, talc and feldspar. The inventors have moreover gained the experimental knowledge, that customary mineral fillers have nearly no influence on the melt strength. This means that alternatively the same moulding material, but without any mineral fillers, can be used by way of comparison of the melt strength, with the same numerical result. For example for blends of polyamide 6 and polyamide 66, the comparison material was a blend of 42% by weight of polyamide 6 and 42% by weight of polyamide 66, 6% by weight of impact modifier and 10% by weight of glass fibres, according to comparative example C4 in Table 2. The melt strength, measured in seconds, is the time required by a tube section cut off at time zero at the die exit and re-emerging at constant volume flow rate of the melt in order to cover a defined measured distance under its own weight. The measured values (in seconds) of corresponding moulding materials can be found in Tables 1 and 2.

In an embodiment, the invention also relates to extrusion blow moulded air conducting articles having substantially reduced surface carbonization at temperatures of use above 135° C. and a duration of use of more than 500 hours, preferably more than 1000 hours and more preferably of more than 3000 hours, and longer retention of the mechanical properties in comparison with articles comprising identical polymers which contain no nano-scale fillers, the wall of the air conducting article consisting of at least one moulding material based on thermoplastic polymers (a) selected from the group consisting of the polyamides (as defined at the outset), the moulding materials furthermore containing in combination:

(b) nano-scale fillers having a particle size of less than 500 nm in at least one dimension in an amount of 0.5 to 15% by weight, based on the total weight of the moulding material,

(c) fibrous filler materials in amounts of up to 65% by weight, preferably of up to 30% by weight, based on the total weight of the moulding material,

(d) impact modifiers in amounts of 0 to 25% by weight, preferably of 3 to 12% by weight, based on the total weight of the moulding material, and optionally further customary additives.

The air conducting articles are preferably charge air pipes for turbochargers in the automotive sector.

The air conducting articles according to embodiments of the present invention can be produced by extrusion blow moulding, co-extrusion blow moulding or sequential blow moulding with or without 3D hose manipulation.

In the polymer systems of the moulding materials according to embodiments of the present invention, in which the filler particles have dimensions in the nanometer range, i.e. in particular with a particle size of less than 500 run in at least one dimension, the following effects are obtained: the thermal coefficient of expansion is substantially reduced in comparison with that of unfilled matrix polymers, particularly in the processing direction, the finely distributed nanoparticles lead to a substantially higher melt stability (at least 30% higher) in comparison with unmodified polyamide. The molecular reinforcement results in a considerable improvement of the mechanical properties, even at relatively high temperatures.

Advantageously used polyamides (PA) for the moulding materials according to embodiments of the present invention are polymers of monomers or monomer mixtures selected from aliphatic lactams or co-aminocarboxylic acids having 4 to 44 carbon atoms, preferably 4 to 18 carbon atoms or polycondensates obtainable from monomers comprising at least one diamine from the group consisting of the aliphatic diamines having 4 to 18 C atoms, the cycloaliphatic diamines having 7 to 22 C atoms and the aromatic diamines having 6 to 22 C atoms in combination with at least one dicarboxylic acid from the group consisting of aliphatic dicarboxylic acids having 4 to 12 C atoms, cycloaliphatic dicarboxylic acids having 8 to 24 C atoms and aromatic dicarboxylic acids having 8 to 20 C atoms. Blends of the abovementioned polymers and/or polycondensates or copolyamides of any desired combinations of said monomers are also suitable. The ω-aminocarboxylic acids or the lactams are selected from the group consisting of ∈-aminocaproic acid, 11-aminoundecanoic acid, 12-aminododecanoic acid, ∈-caprolactam, enantholactam, ω-laurolactam or mixtures thereof.

Furthermore, it is possible according to embodiments of the present invention to use blends of the abovementioned polymers or polycondensates. Diamines which are suitable according to embodiments of the present invention and which are combined with a dicarboxylic acid are, for example, 2,2,4- or 2,4,4-trimethylhexamethylenediamine, cyclohexyldimethyleneamine, bis(p-aminocyclohexyl)methane, m- or p-xylylenediamine, 1,4-diaminobutane, 1,6-diaminohexane, methylpentamethylenediamine, nonanediamine, methyloctamethylenediamine, 1,10-diaminodecane, 1,12-diaminododecane and cyclohexyldimethyleneamine, and the dicarboxylic acids are selected from the group consisting of succinic acid, glutaric acid, adipic acid, suberic acid, pimelic acid, suberic acid, azelaic acid, sebacic acid, dodecanedicarboxylic acid, cyclohexanedicarboxylic acid, terephthalic acid, isophthalic acid, naphthalenedicarboxylic acid. It is of course possible to use for copolyamides any desired mixtures of monomers mentioned, and, in the case of polyamide elastomers, additionally building blocks which lead to ester, ether-ester or ether units or blocks (e.g. diols or polyethers having hydroxyl or amino terminal groups).

Specific examples of the polyamides for the moulding materials according to embodiments of the present invention are therefore those homo- or copolyamides from the group consisting of PA 6, PA 46, PA 66, PA 11, PA 12, PA 1212, PA 1012, PA 610, PA 612, PA 69, PA 99, PA 9T, PA 10T, PA 12T, PA 121, mixtures thereof or copolymers based on these polyamides, PA 11, PA 12, PA 1212, PA 9T, PA 10T, PA 12T, PA 12T/12, PA 10T/12, PA12T/106, PA10T/106 or mixtures thereof being preferred. According to embodiments of the present invention, it is furthermore possible to use copolyamides such as PA 6/66, PA 6/612, PA 6/66/610, PA 6/66/12, PA 6T/66, PA 6T/66/12, PA 6/6T, PA 6T/6, PA 6T/12, PA 6/6I, PA 6T/6I, PA 6I/6T or mixtures thereof, or PA 12/MACMI, PA 66/6I/6T, PAMXD 6/6. Mixtures of PA 6 and PA 66, and also polyamide elastomers such as, for example, polyester amides, polyetheresteramides and polyetheramides are preferred.

The polyamides of the present invention are preferably partially crystalline. The invention relates to aliphatic, cycloaliphatic or partly aromatic polyamides which are however not always partially crystalline over their entire composition range and consequently do not always have a melting point. A simple method to differentiate between partially crystalline and the less preferred amorphous polyamides is to detect whether there is a melting point by means of differential scanning calorimetry (DSC). Amorphous polyamides do not show a melting point. In WO 2004/055084 A2 different further ways to decide whether a polyamide is partially crystalline or amorphous are mentioned.

The polyamides (PA 6, PA 66) for the moulding materials according to embodiments of the present invention preferably have a relative viscosity (measured on a 1.0% by weight solution of sulphuric acid at 20° C.) of 2.3 to 4.0, in particular of 2.6 to 3.8.

For certain purposes, however, other customary polymers such as polyesters, polycarbonates, polyolefins, (e.g. polyethylene or polypropylene), polyethylenevinyl alcohols, styrene polymers, fluoropolymers, polyphenylene sulphide or polyphenylene oxide in amounts of up to 50% by weight, in particular of up to 30% by weight, can also be added to the polyamides or mixtures described above.

The polyamide moulding materials according to embodiments of the present invention contain at least 30% by weight of polyamide, preferably at least 50% by weight of polyamide. However, it is also possible to use a copolymer comprising polyamide building blocks in addition to said polyamides or alone in the moulding materials. Such a copolymer contains at least 20% by weight of polyamide building blocks. In a preferred embodiment, this copolyamide contains at least 30% by weight of polyamide building blocks, preferably at least 40% by weight of polyamide building blocks. The copolymer may be a block copolymer which contains polyester, polyether, polysiloxane, polycarbonate, polyacrylate, polymethacrylate or polyolefin segments as further building blocks in addition to a proportion of at least 20% by weight, in particular 30% by weight, preferably 40% by weight, of polyamide building blocks.

Furthermore, the polyamides used and the moulding materials optionally contain customary additives such as UV and heat stabilizers, antioxidants, crystallization accelerators, crystallization retardants, nucleating agents, flow improvers, lubricants, mould release agents, plasticizers, flame retardants, pigments, dyes and agents which can improve the electrical conductivity (carbon black, graphite fibrils, etc.).

As further additives, impact modifiers may be added to the thermoplastic polymers according to embodiments of the present invention, in particular the polyamides or polyamide moulding materials. The impact modifiers, which may be combined with the polyamide and the nano-scale fillers, in particular the nanofiller in the context according to embodiments of the present invention, are preferably polyolefin-based polymers which may be functionalized, for example, with maleic anhydride. Impact modifiers such as ethylene-propylene rubbers (EPM, EPR) or ethylene-propylene-diene rubbers (EPDM), styrene-containing elastomers, e.g. SEBS, SBS or SEPS, or acrylate rubbers may be mentioned in particular here. However, nitrile rubbers (NBR, H-NBR), silicone rubbers, ethylene vinyl acetate (EVA) and microgels, as described in WO 2005/033185 A1, and mixtures of different impact modifiers are also suitable as impact modifiers.

Suitable nano-scale fillers for the production of nanocomposites according to embodiments of the present invention are those substances which can be added in any desired stage of the production and can be finely dispersed in the nanometer range. The nano-scale fillers according to embodiments of the present invention may have been surface-treated. However, it is also possible to use untreated fillers or mixtures of untreated and treated fillers. The nano-scale fillers have a particle size of less than 500 nm in at least one dimension. The fillers are preferably minerals which already have a layer structure such as layered silicates and double hydroxides.

The nano-scale fillers used according to embodiments of the present invention are selected from the group consisting of the oxides or hydrated oxides of metals or semimetals. In particular, the nano-scale fillers are selected from the group consisting of the oxides and hydrated oxides of an element selected from the group consisting of boron, aluminium, calcium, gallium, indium, silicon, germanium, tin, titanium, zirconium, zinc, yttrium or iron.

In a particular embodiment of the invention, the nano-scale fillers are either silicon-dioxide or silicon-dioxide hydrates. In the polyamide moulding material, the nano-scale fillers are present in one embodiment as a uniformly dispersed, layer-like material. Prior to incorporation into the matrix, they have a layer thickness of 0.7 to 1.2 nm and an interlayer spacing of the mineral layers of up to 5 nm.

Minerals which are preferred according to embodiments of the present invention and already have a layer structure are natural and synthetic layered silicates and double hydroxides such as hydrotalcite. According to embodiments of the present invention, nanofillers based on silicones, silica or silsesquioxanes are also suitable.

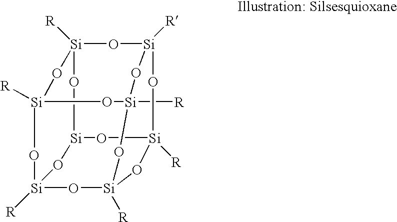

As used herein, layered silicates mean 1:1 and 2:1 layered silicates. In these systems, layers of SiO₄ tetrahedra are linked in a regular manner together with layers of M(O,OH)₆ octahedra. Therein, M represents metal ions such as Al, Mg or Fe. In the 1:1 layered silicates, in each case 1 tetrahedra layer and one octahedral layer are connected to one another. Examples of this are kaolin and serpentine minerals.

In the case of the 2:1 layered silicates, in each case two tetrahedra are combined with one octahedral layer. If all octahedral sites are not occupied by cations of the required charge for compensating the negative charge of the SiO₄ tetrahedra and of the hydroxide ions, charged layers occur. This negative charge is compensated by the incorporation of monovalent cations such as potassium, sodium or lithium, or divalent ones such as calcium, into the space between the layers. Examples of 2:1 layered silicates are talc, vermiculites, illites and smectites, the smectites, to which montmorillonite also belongs, being easily swellable with water owing to their layer charge. Furthermore, the cations are easily accessible for exchange processes.

The nano-scale fillers can be selected from the group consisting of the natural and synthetic layered silicates, in particular from the group consisting of bentonite, smectite, montmorillonite, saponite, beidellite, nontronite, hectorite, stevensite, vermiculite, illites and pyrosite, or the group consisting of the kaolin and serpentine minerals, double hydroxides or those fillers based on silicones, silica or silsesquioxanes being preferred.

The layer thicknesses of the layered silicates are usually 0.5-2.0 mn, very particularly 0.8-1.5 nm (distance from the upper edge of the layer to the upper edge of the following layer) prior to swelling. It is possible thereby to further increase the layer spacing by reacting the layered silicate, for example, with polyamide monomers, for example, at temperatures of 25-300° C., preferably of 80-280° C. and in particular of 80-160° C. over residence time of, as a rule, 5-120 minutes, preferably of 10-60 minutes (swelling). Depending on the type of residence time and the type of the monomers selected, the layer spacing additionally increases by 1-15 nm, preferably by 1-5 nm. The length of the platelets is usually up to 800 nm, preferably up to 400 nm. Any prepolymers present or prepolymers forming also generally contribute to the swelling of the layered silicates.

The swellable layered silicates are characterized by their ion exchange capacity CEC (meq/g) and their layer spacing dL. Typical values for CEC are 0.7 to 0.8 meq/g. The layer spacing in the case of dry untreated montmorillonite is 1 nm and increases to values up to 5 nm by swelling with water or coating with organic compounds.

Examples of cations which may be used for exchange reactions are ammonium salts of primary amines having at least 6 carbon atoms such as hexylamine, decylamine, dodecylamine, stearylamine, hydrogenated fatty acid amines or even quaternary ammonium compounds and ammonium salts of α-,ω-amino acids having at least 6 carbon atoms. Further nitrogen-containing activation reagents are triazine-based compounds. Such compounds are described, for example, in EP-A-1 074 581, and particular reference is therefore made to this document.

Suitable anions are chlorides, sulphates or even phosphates. In addition to ammonium salts, it is also possible to use sulphonium or phosphonium salts such as, for example, tetraphenyl- or tetrabutylphosphonium halides.

Because polymers and minerals usually have very different surface tensions, it is also possible according to embodiments of the present invention to use adhesion promoters for the treatment of the minerals in addition to cation exchange. Where this is done, titanates or even silanes such as γ-aminopropyltriethoxysilane, are suitable. The adhesion promoters can preferably be present in amounts of up to 10% by weight in the moulding material.

Thus, as described above, layered silicates which have been modified with onium ions can be used according to embodiments of the present invention. However, it is also possible to use phyllosilicates which are not surface-treated and which have then been reacted according to WO 99/29767 (DSM). The polyamide nanocomposite is then produced by first mixing the polyamide with the untreated clay mineral in a mixer, introducing this mixture into the feed zone of an extruder and, after production of a melt, injecting up to 30% of water, allowing the water to escape through the devolatilization opening and then allowing the melt to discharge through a die. The extrudate obtained can then be further processed to give pellets.

In various embodiments, fibrous filler materials in amounts of up to 65% by weight, preferably up to 45% by weight, more preferably up to 30% by weight, based on the total weight of the moulding material, are added as further fillers. Examples of suitable fibrous fillers are glass fibres, in particular E glass fibres, carbon fibres, potassium titanate whiskers or aramide fibres. With the use of glass fibres these can be finished with a size and an adhesion promoter for a better compatibility with the matrix material. In general, the carbon fibres and glass fibres used have a diameter in the range of 6-16 μm. The incorporation of the glass fibres can be effected both in the form of short glass fibres and in the form of continuous strands (rovings).

The moulding materials according to embodiments of the present invention can moreover contain further additives. For example, processing assistants, stabilizers and antioxidants, agents for preventing thermal decomposition and decomposition by ultraviolet light, lubricants and mould release agents, flame retardants, dyes, pigments and plasticizers may be mentioned as such additives.

Pigments and dyes are generally present in amounts of 0 to 4% by weight, preferably of 0.5 to 3.5% by weight and more preferably of 0.5 to 2% by weight, based on the total weight of the composition. The pigments for coloring thermoplastics are generally known, see for example, R. Gächter and H. Müller, Taschenbuch der Kunstoffadditive [Pocketbook of Plastic Additives], Carl Hanser Verlag, 1983, pages 494-510.

Black pigments, which may be used according to embodiments of the present invention are iron oxide black (Fe₃O₄), manganese black (mixture of manganese dioxide, silicon dioxide and iron oxide) and preferably carbon black, which is generally used in the form of furnace black or gas black (see in this context G. Benzing, Pigmente für Anstrichmittel [Pigments for Paints], Expert-Verlag (1998), page 78 et. seq.).

According to embodiments of the present invention, inorganic colored pigments or organic colored pigments such as azo pigments and phthalocyanines, can of course be used for establishing certain tints. Generally, such pigments are commercially available.

Furthermore, it may be advantageous to use said pigments or dyes in mixtures, for example, carbon black with copper phthalocyanines, since in general the color dispersion in the thermoplastic is facilitated.

Antioxidants and heat stabilizers which can be added to the thermoplastic materials according to embodiments of the present invention are, for example, halides of metals of group I of the Periodic Table of the Elements, e.g. sodium, potassium and lithium halides, if required in combination with copper (I) halides, e.g. chlorides, bromides or iodides. The halides, in particular of copper may also contain electron-rich π-ligands. Cu halide complexes with, for example, triphenylphosphine may be mentioned as an example of such copper complexes. Furthermore, sterically hindered phenols, if required in combination with phosphorous-containing acids or salts thereof, and mixtures of these compounds in general in concentrations up to 1% by weight, based on the weight of the mixture, may be used.

Examples of UV stabilizers are various substituted benzotriazoles and sterically hindered amines (HALS), which are generally used in amounts of up to 2% by weight.

Lubricants and mould release agents, which as a rule are added in amounts of up to 1% by weight to the thermoplastic material, are stearic acid, stearyl alcohol, alkyl stearates and stearamides and esters of pentaerythritol with long-chain fatty acids. Calcium, magnesium, zinc or aluminium salts of stearic acid can also be used.

The production of the moulding materials according to embodiments of the present invention can be effected in various ways. Diverse procedures can be used for the production of the moulding materials according to embodiments of the present invention. The production can be effected, for example, by means of a process carried out discontinuously or continuously. Theoretically, the production of the moulding materials according to embodiments of the present invention can be effected by introducing the layered silicates during the polymerization or by subsequent compounding in an extrusion method. Such production methods are described, for example, in DE-A-199 48 850, which is incorporated herein by reference.

According to embodiments of the present invention, however, it was found that, if the layered silicates and fibrous filler materials and impact modifiers are produced by subsequent compounding in an extrusion method, it is possible to produce particularly suitable moulding materials which can be processed by injection moulding, extrusion and other methods afterwards to give any desired moulded articles.

The nanocomposite moulding materials according to embodiments of the present invention were therefore produced in the experiments, for example, by means of extrusion methods, i.e. on a compounding extruder, in the present case on a 25 mm ZSK 25 twin-screw extruder from Werner & Pfleiderer at temperatures between 240° C. and 350° C. The polymers were first melted and the silicate mineral was metered into the feed zone of the extruder and, if required, the glass fibres were metered into the melt, and the nanocomposites obtained were cut into pellet form after cooling in water.

However, it is also possible alternatively for the layered silicate first to be mixed in suspension or as a solid with the polymerizable monomers (e.g. lactam) and to be swelled. Thereafter, the polymers and the silicate mineral thus modified are introduced into the feed zone of an extruder and, if required, glass fibres are metered in to the melt. These nanocomposites obtained are, if required, then compounded with further components such as the mineral fillers and the impact modifiers and, if required, further additives.

In a further alternative process, the nano-scale fillers are mixed in suspension or as a solid with the full amount of the monomers polymerizable to the thermoplastic, i.e. in the polymerization batch. Swelling of the layered silicate with the monomers takes place. The subsequent polymerization of the monomers can be carried out as usual in the polymerization reactor. The nanocomposites obtained are, if required, then further processed with the further components such as filler materials, impact modifiers and the further additives.

In an alternative embodiment, as in the above mentioned experiments, the thermoplastic nanocomposites can be obtained by mixing the polyamide and the layered silicate and, if required, the further mineral filler materials and, if required, the impact modifier and the other additives by methods understood by the skilled artisan, for example, by means of extrusion at temperatures in the range from 160° C. to 350° C., preferably at 240° C. to 300° C. In particular, a twin-screw extruder with high shearing is suitable for this purpose, shear stresses according to DIN 11443 of 10 to 10⁵ Pa, in particular of 102 to 104 Pa, preferably being present.

The resulting thermoplastic nanocomposites according to embodiments of the present invention are preferably distinguished by a higher melt strength if they are provided for extrusion blow moulding. However, they can be used generally for the production of any desired mouldings by any production process.

In an alternative embodiment, the present invention provides extrusion blow moulded air conducting articles having substantially reduced surface carbonization at temperatures of use above 135° C. and a duration of use of, for example, more than 500 hours and longer retention of the mechanical properties (elongation at break and/or ultimate tensile strength on 4 mm bars, measured according to ISO 527) in comparison with articles comprising the same polyamides which contain no nano-scale fillers, the wall of the air conducting article consisting of at least one moulding material based on thermoplastic polymers selected from the group consisting of the polyamides (as defined at the outset), the moulding material furthermore containing in combination: nano-scale fillers in an amount of from 0.5 to 15% by weight, fibrous filler materials in amounts of up to 65% by weight, impact modifiers in amounts of 0 to 25% by weight, in particular 3 to 12% by weight, based in each case on the total weight of the moulding material, and, if required, further customary additives, the thermal stability and the carbonization behavior of the articles being better. In another embodiment, the melt strength of the moulding material is moreover higher by at least 30% compared with other moulding materials which contain only customary mineral filler materials instead of the nano-scale fillers.

The abovementioned extrusion blow moulded air conducting articles are in particular charge air pipes. In an alternative embodiment, it is also possible to use a further moulding material in addition to a first moulding material, the tensile moduli of elasticity differing by at least a factor of 1.2 but both moulding materials containing polyamide as components. The further moulding material may be composed of 0 to 80% by weight of a rubber-elastic polymer, in particular of a core-shell polymer, and 100 to 20% by weight of a polyamide. Thus, the air conducting article or the charge air pipe contains an alternating composition of rigid and flexible segments over its entire length. This can be achieved, for example, by sequential blow moulding, i.e. sequential co-extrusion with alternating material streams. This can be done by feeding the shaping die alternately from one of the extruders, i.e. alternately with the first moulding material or the second moulding material. As a result, a hose is extruded which has an alternating composition with segments of in each case only one of the two moulding materials or a different layer thickness ratio over its entire length.

The air conducting articles according to embodiments of the present invention may also have wavy sections or contain wavy regions. Certain embodiments of the present invention are directed to particular pipe geometries, i.e. certain corrugated pipe geometries. In this context, reference is made to EP 0 863 351 B1 (EMS).

### EXAMPLES

By way of example and not limitation, the following examples are provided.

Materials Used:

Polyamides

| | Relative | Relative | Volume flow |
|---|---|---|---|
| | viscosity | viscosity | index (MVR) |
| Polyamide | 1% in sulphuric | 0.5% in m- | at 275° C./5 kg |
| type | acid 20° C. | cresol 20° C. | (cm³/10 min) |
| PA6 | 3.40 | | 30 |
| PA66 | 2.75 | | 60 |
| PA12 | | 2.25 | 25 |

Layered Silicate

Na-montmorillonite treated (modified) with 35 meq of dimethyl-hydrogenated tallow-ammonium hydrochloride per 100 g of mineral.

In the case of the tensile bars with the number 3 from FIG. 4, Na montmorillonite in which the cation exchange was carried out with methyl-tallow-bis-2-hydroxyethyleammonium chloride was used (90 meq/100 g of mineral).

d_{L}: 1.85 nm (corresponds to the two organically modified layered silicates).

Impact Modifier

Ethylene-propylene copolymer, grafted with maleic anhydride.

MVR 275° C./5 kg: 13 cm³/10 min

Melting point DSC: 55° C.

Glass Fibre

E-glass, polyamide type, diameter 10 μm, length 4.5 mm.

The nanocomposite moulding materials according to embodiments of the present invention were produced on a 25 mm ZSK 25 twin-screw extruder from Werner & Pfleiderer at temperatures between 240 and 300° C. The polymers and the silicate minerals were metered into the feed zone of the extruder and, if required, glass fibres were metered in to the melt.

The testing of the moulding materials according to embodiments of the present invention and moulding materials not according to embodiments of the present invention was carried out according to the following methods:

MVR: (melt volume rate) at 275° C./21.6 kg or 5 kg according to ISO 1133 (cm³/10 min). (MVR is identical to the volume flow index previously designated as MVI)

IS: Impact strength according to ISO 179/leU

The elongation at break (EB) and ultimate tensile strength (TS) were determined according to ISO 527 on 4 mm bars.

Ash content: residue after combustion at 1000° C.: effective proportion of montmorillonite (in the moulding materials of Table 3, which contain no glass fibres).

The following explanation is given for the definition of the term “melt strength” or for the determination of the melt strength:

As used herein, melt strength means the “stability” of the thermoplastic article, for example, the parison. In the case of a high melt strength, the parison remains stable, whereas the parison lengthens to a greater extent in the case of a low melt strength.

This means that materials which have a high melt strength are required for processing by blow moulding.

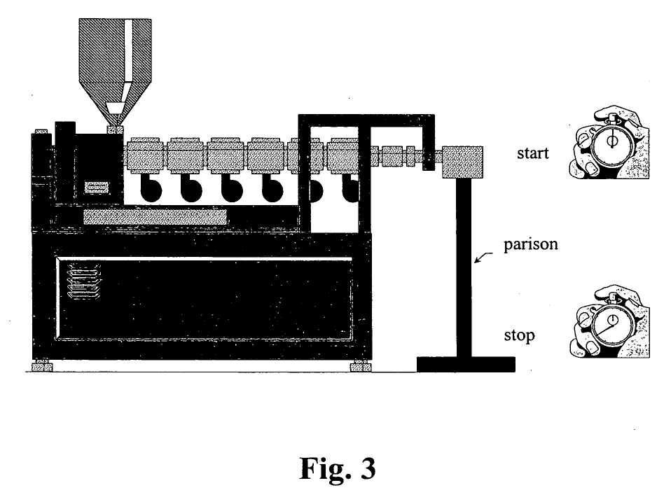

For this purpose, the Applicant has developed his own method in which the melt strength is assessed. In this method, a hose is extruded continuously via an angle head. The time which the hose requires to cover the distance (e.g. 1 meter) from the die to the floor is used as the quantity to be measured. The measurement of the melt strength is carried out with a constant output and a temperature profile adapted to the polymer type (see FIG. 3).

As is evident from FIG. 3, the time measurement is started at the moment when the continuously emerging melt hose is cut off at the extrusion die with a spatula. The time is stopped as soon as the newly emerging and downward migrating hose section touches the floor.

A material which can poorly support its own increase in weight (due to the continuously extruded melt), i.e. begins to exhibit viscous extension, will lengthen to a greater extent and the tip of the melt hose will thus touch the floor earlier (i.e. the shorter measured time corresponds to a lower melt strength).

A practical advantage is that the exact machine settings such as, for example, temperature, throughput, hose die and measuring height, play no absolute role because these are comparative measurements in which the time measured in seconds can be converted into percentages. All that is important therefore is that exactly the same apparatus with the same settings is used in the case of the material variants which are directly compared with one another. The (relative) melt strength expressed in percentages is reproducible for the person skilled in the art even on testing machines which are not identical, because comparative melt strength measurements are applicable with respect to percentage. For example, the statement “at least 30% higher melt strength” is therefore sufficiently informative.

As shown in the following tables, the polyamide moulding materials according to embodiments of the present invention which are investigated there have a high melt strength. For polyamide 6, polyamide 66, polyamide 12 or mixtures of polyamide 66 and polyamide 6, high melt strengths are measured at the temperatures stated in Tables 1 and 2 for unreinforced and reinforced polyamides.

In the Tables below, the advantages of the moulding materials according to embodiments of the present invention are shown, the experiments beginning with C being the comparative examples not according to embodiments of the present invention.

TABLE 1
Unreinforced polyamides

| | | Example 1 | C1 | Example 2 | C2 | Example 3 | C3 |
|---|---|---|---|---|---|---|---|
| PA6 | % by wt. | 94 | 100 | 47 | 50 | — | — |
| PA66 | % by wt. | — | — | 47 | 50 | — | — |
| PA12 | % by wt. | — | — | — | — | 94 | 100 |
| Layered silicate | % by wt. | 6 | — | 6 | — | 6 | — |
| Melt strength 240° C. | s* | — | — | — | — | 27 | 21 |
| Melt strength 260° C. | s* | 20 | 6 | — | — | — | — |
| Melt strength 280° C. | s* | — | — | 15 | 7 | — | — |

*s = seconds

TABLE 2
reinforced polyamides

| | | Example 4 | Example 5 | C4 |
|---|---|---|---|---|
| PA6 | % by wt. | 40 | 39 | 42 |
| PA66 | % by wt. | 40 | 39 | 42 |
| Impact modifier | % by wt. | 4 | 6 | 6 |
| Layered silicate | % by wt. | 6 | 6 | — |
| Glass fibres | % by wt. | 10 | 10 | 10 |
| Melt strength 280° C. | s | 42 | 50 | 15 |
| MVR 275° C./21.6 kg | cm³/10 min | 94 | 50 | 170 |
| Tensile modulus of | MPa | 5750 | 5600 | 4900 |
| elasticity 23° C. | | | | |
| Tensile modulus of | MPa | 1900 | 1800 | 1200 |
| elasticity 100° C. | | | | |
| Tensile modulus of | MPa | 1450 | 1330 | 1150 |
| elasticity 150° C. | | | | |

TABLE 3
elongation at break on 4 mm bars, measured according to ISO 527

| | | Example 6 | C5 |
|---|---|---|---|
| PA6 | % by wt. | 46.8 | 49.8 |
| PA66 | % by wt. | 46.8 | 49.8 |
| Layered silicate | % by wt. | 6 | |
| Heat stabilizer (Cu-containing) | % by wt. | 0.4 | 0.4 |
| Ash content | % by wt. | 4 | 0.1 |
| Initial value of elongation | % | 13.4 | 15.2 |
| at break, not stored | | | |
| Elongation at break after | % | 11.1 | 5.8 |
| oven storage for 400 h at | | | |
| 200° C. | | | |

Example 7: Hollow bodies (air conducting articles) were produced by means of extrusion blow moulding from the following polyamide moulding material having the following composition:

Polyamide 6 and polyamide 66, impact-modified, 15% of glass fibres, 6% by weight of layered silicate.

After storage of the parts for more than 500 hours at 200° C., no degradation due to thermal oxidation could be found on the inner and outer surface in the case of the moulded articles according to embodiments of the present invention. In comparison in the case of parts which contain no nanofillers, a substantial degradation process due to thermal oxidation could be found on the surface and could be monitored by pronounced carbon formation on the surface.

TABLE 4

| | | Example 8 | C6 |
|---|---|---|---|
| PA6 | % by wt. | 29.3 | 32.3 |
| PA66 | % by wt. | 29.3 | 32.3 |
| Glass fibres | % by wt. | 30 | 30 |
| Layered silicate | % by wt. | 6 | 0 |
| Impact modifier | % by wt. | 5 | 5 |
| Heat stabilizer (Cu-containing) | % by wt. | 0.4 | 0.4 |

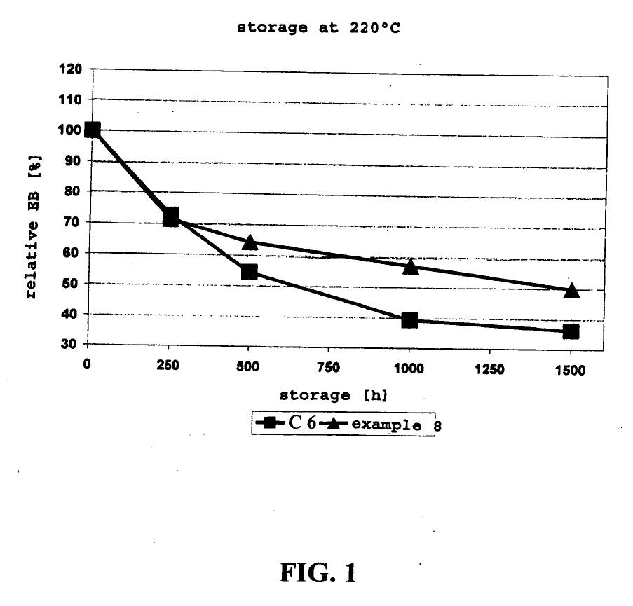

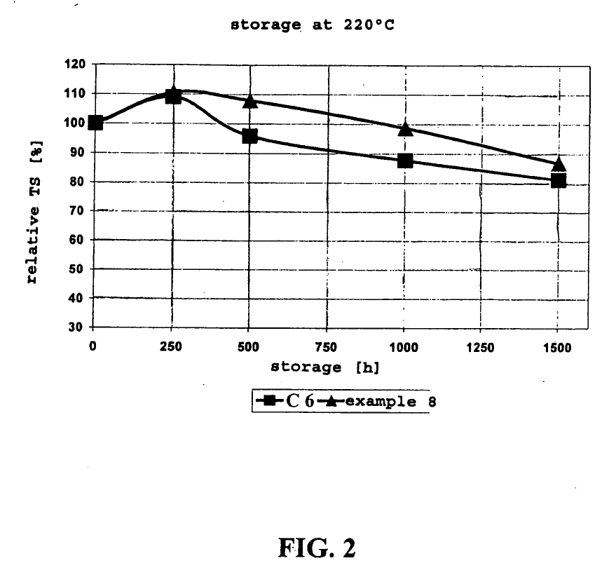

(for properties, see FIG. 1 and FIG. 2)

Example 8 shows significantly longer retention of the mechanical properties in comparison with the comparative variant C6, especially in the case, of long-term storage at elevated temperature, measured in terms of relative elongation at break EB (see FIG. 1) and the relative ultimate tensile strength TS (see FIG. 2). Here, “relative” means, based on the absolute initial values, prior to storage at elevated temperature, the ultimate tensile strength and elongation at break on 4 mm bars, measured according to ISO 527.

FIG. 4 shows the tensile test bars shown in pairs. In each case, the light one is a tensile test bar prior to the storage at elevated temperature and the black one is a tensile test bar of the same composition after storage for 408 hours at 230° C. The tensile test bars with the numbers 1, 2 and 3 were produced from different moulding materials: bar 1: PA6/PA66 (1:1); bar 2: PA6/PA66 (1:1) with 5% of impact modifier; and bar 3 (example according to embodiments of the present invention), PA6/PA66 (1:1) with 5% of impact modifier and 6% montmorillonite (modified according to second stated layered silicate modification). All three variants also contained 0.4% of heat stabilizer (Cu-containing). After storage at elevated temperature, the comparative bars 1 and 2 show substantial surface defects due to carbonization, whereas bar 3 according to embodiments of the present invention merely has a darker color after storage at elevated temperature but its surface is still intact.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of producing a moulded article, the method comprising:
providing at least one thermoplastic polymer selected from the group consisting of polyamides and combinations thereof,
combining the thermoplastic polymer with at least one nano-scale filler that is less than 500 nm in at least one dimension to produce a moulding material, wherein the nano-scale filler ranges in an amount from about 0.5 to about 15% by weight of the total weight of the moulding material; and
forming the moulded article from the moulding material, wherein the molded article has a longer retention of mechanical properties and a reduced surface carbonization when the moulded article is used at a temperature above 135° C. in comparison with a moulded article comprising the same polyamide that contains no nano-scale fillers.

2. The method of claim 1, wherein the moulded article has a reduced surface carbonization when used at a temperature above 150° C. for a duration of more than 500 hours.

3. The method of claim 1, wherein the moulding material comprises up to 65% by weight of the total weight of the moulding material of reinforcing materials.

4. The method of claim 1, wherein the moulding material comprises impact modifiers in amount from about 1 to about 25% by weight of the total weight of the moulding materials.

5. The method of claim 1 comprising combining the moulding material with a second moulding material comprising a second polyamide polymer, wherein the tensile moduli of elasticity of the two moulding materials differ by at least a factor of 1.2.

6. The method of claim 5, wherein the moulding material comprises from about 1 to 80% by weight of a rubber-elastic polymer and from about 20 to 99% by weight of a polyamide.

7. The method of claim 1, wherein the polyamide comprises a viscosity of 2.3 to 4.0, measured on a 1.0% by weight solution in sulphuric acid at 20° C.

8. The method of claim 1, wherein the moulding material comprises from about 1% to about 10% by weight of the nano-scale filler and up to 30% by weight of a fibrous filler material based on the total weight of the moulding material.

9. The method of claim 1, wherein the nano-scale filler is selected from the group consisting of bentonite, smectite, montmorillonite, saponite, beidellite, nontronite, hectorite, stevensite, vermiculite, illite, pyrosite, kaolin, serpentine, double hydroxides based on silicone, silica, silsesquioxane and combinations thereof.

10. The method of claim 9, wherein the filler has been treated with adhesion promoters and the adhesion promoter is present in an amount up to about 10% by weight of the moulding material.

11. The method of claim 1, wherein the polyamide is a polymer of monomers or monomer mixtures selected the group consisting of aliphatic lactams having 4 to 44 carbon atoms, ω-aminocarboxylic acids having 4 to 44 carbon atoms, polycondensates obtained from monomers comprising at least one diamine and at least one dicarboxylic acid and combinations thereof.

12. The method of claim 11, wherein the diamine is selected from the group consisting of aliphatic diamines having 4 to 12 C atoms, cycloaliphatic diamines having 7 to 22 C atoms, the aromatic diamines having 6 to 22 C atoms and combinations thereof.

13. The method of claim 11, wherein the dicarboxylic acid is selected from the group consisting of aliphatic dicarboxylic acids having 4 to 12 C atoms, cycloaliphatic dicarboxylic acids having 8 to 24 C atoms, aromatic dicarboxylic acids having 8 to 20 C atoms and combinations thereof.

14. The method of claim 11, wherein the polyamide comprises an additional building block selected from the group consisting of diols, polyethers having hydroxyl terminal groups, polyethers having amino terminal groups and combinations thereof.

15. The method of claim 11, wherein the lactams and the ω-aminocarboxylic acids are selected from the group consisting of ∈-aminocaproic acid, 11-aminoundecanoic acid, 12-aminododecanoic acid, ∈-caprolactam, enantholactam, ω-laurolactam and combinations thereof.

16. The method of claim 11, wherein the diamine is selected from the group consisting of 2,2,4- or 2,4,4-trimethylhexamethylenediamine, cyclohexyldimethyleneamine, bis(p-aminocyclohexyl)methane, m- or p-xylylenediamine, 1,4-diaminobutane, 1,6-diaminohexane, methylpentamethylenediamine, nonanediamine, methylocta-methylenediamine, 1,10-diaminodecane, 1,12-diaminododecane, cyclohexyldimethylene-amine and combinations thereof and the dicarboxylic acid is selected from the group consisting of succinic acid, glutaric acid, adipic acid, suberic acid, pimelic acid, suberic acid, azelaic acid, sebacic acid, dodecanedicarboxylic acid, cyclohexanedicarboxylic acid, terephthalic acid, isophthalic acid, naphthalenedicarboxylic acid and combinations thereof.

17. The method of claim 1, wherein the polyamide comprises homopolyamides or copolyamides selected from the group consisting of polyamide 6, polyamide 46, polyamide 66, polyamide 11, polyamide 12, polyamide 1212, polyamide 1012, polyamide 610, polyamide 612, polyamide 69, polyamide 99, polyamide 9T, polyamide 12T, polyamide 10T, polyamide 121, polyamide 12T, polyamide 12T/12, polyamide 10T/12, polyamide 12T/106, polyamide 10T/106, polyamide 6/66, polyamide 6/612, polyamide 6/66/610, polyamide 6/66/12, polyamide 6/6T, PA 6T/6, PA 6T/12, polyamide 6T/6I, polyamide 6I/6T, polyamide 6/6I, polyamide 6T/66, polyamide 6T/66/12, polyamide 12/MACMI, polyamide 66/6I/6T, polyamide MXD6/6, polyesteramides, polyetheresteramides, polyetheramides and combinations thereof.

18. The method of claim 1 comprising adding to the moulding material a polymer selected from the group consisting of polyesters, polycarbonates, polyolefins, polyethylenevinyl alcohols, styrene polymers, fluoropolymers, polyphenylene sulphide, polyphenylene oxide and combinations thereof.

19. The method of claim 1 comprising adding to the moulding material an additive selected from the group consisting of UV and heat stabilizers, antioxidants, pigments, dyes, nucleating agents, crystallization accelerators, crystallization retardants, flow improvers, lubricants, mould release agents, plasticizers, flame retardants, agents that improve the electrical conductivity and combinations thereof.

20. The method of claim 1 comprising adding glass fibres to the moulding material.

21. The method of claim 1 comprising adding to the moulding material an impact modifier selected from the group consisting of ethylene-propylene rubbers, ethylene-propylene-diene rubbers, acrylate rubbers, styrene-containing elastomers, nitrile rubbers, silicone rubbers, ethylene vinyl acetate, microgels and combinations thereof.

22. The method of claim 1, wherein the moulded article is formed by a process selected from the group consisting of injection moulding, extrusion moulding, extrusion blow moulding, with or without 3D blow moulding and combinations thereof.

23. The method of claim 22, wherein the extrusion blow moulded article comprises an air conducting article for motor vehicles.

24. The method of claim 23, wherein the air conducting article comprises a charge air pipe for turbochargers in an automotive sector.

25. The method of claim 22, wherein the moulding material comprises a highly viscous extrusion blow moulding material.

26. A moulding material suitable for an extrusion blow moulding process comprising:
(a) at least one thermoplastic polymer selected from the group consisting of polyamides and combinations thereof;
(b) at least one nano-scale filler having a particle size of less than 500 nm in at least one dimension, the nano-scale filler in an amount of 0.5 to 15% by weight of the total weight of the moulding material,
(c) at least one fibrous filler material in amounts up to about 65% by weight of the total weight of the moulding material, preferably about 5 to about 30% by weight, and
(d) at least one impact modifier in an amount from about 0 to about 25% by weight, preferably about 3 to about 12% by weight, of the total weight of the moulding material, wherein a molded article produced from said moulding material has a longer retention of mechanical properties (elongation at break and/or ultimate tensile strength) and a reduced surface carbonization when the moulded article is used at a temperature above 135° C. in comparison with a moulded article comprising the same thermoplastic polymer that contains no nano-scale fillers.

27. The moulding material of claim 26, wherein the moulding material comprises a melt strength at least 30% higher than the same moulding materials which, instead of the nano-scale fillers, contain only customary mineral fillers such as, for example, amorphous silicic acid, kaolin, magnesium carbonate, mica, talc and feldspar.

28. The moulding material of claim 26, wherein the moulding material comprises a second moulding material comprising a second thermoplastic polymer selected from the group consisting of polyamides, polyesters, polyetheresters, polyesteramides and combinations thereof, wherein the tensile moduli of elasticity of the two moulding materials differ by at least a factor of 1.2.

29. The moulding material of claim 28, wherein the second moulding material is composed of 0 to 80% by weight of a rubber-elastic polymer and 100 to 20% by weight of a polyamide.

30. The moulding material of claim 26, wherein the polyamides for the moulding materials have a relative viscosity, measured on a 1.0 percent by weight solution in sulphuric acid at 20° C., of 2.3 to 4.0.

31. The moulding material of claim 26, wherein nano-scale fillers in an amount of 2-10% by weight and, as further additives, fibrous filler materials in an amount of 0-30% by weight, based in each case on the total weight of the moulding material, are present in the moulding materials.

32. The moulding material of claim 31, wherein the nano-scale fillers are selected from the group consisting of natural and synthetic layered silicates, bentonite, smectite, montmorillonite, saponite, beidellite, nontronite, hectorite, stevensite, vermiculite, illite, pyrosite, kaolin, serpentine, double hydroxides based on silicone, silica, silsesquioxane.

33. The moulding material of claim 32, wherein the mineral has been treated with adhesion promoters and the adhesion promoter is present in an amount of up to 10% by weight in the moulding material.

34. The method of claim 26, wherein the polyamide is a polymer of monomers or monomer mixtures selected the group consisting of aliphatic lactams having 4 to 44 carbon atoms, ω-aminocarboxylic acids having 4 to 44 carbon atoms, polycondensates obtained from monomers comprising at least one diamine and at least one dicarboxylic acid and combinations thereof.

35. The method of claim 34, wherein the diamine is selected from the group consisting of aliphatic diamines having 4 to 12 C atoms, cycloaliphatic diamines having 7 to 22 C atoms, the aromatic diamines having 6 to 22 C atoms and combinations thereof.

36. The method of claim 34, wherein the dicarboxylic acid is selected from the group consisting of aliphatic dicarboxylic acids having 4 to 12 C atoms, cycloaliphatic dicarboxylic acids having 8 to 24 C atoms, aromatic dicarboxylic acids having 8 to 20 C atoms and combinations thereof.

37. The method of claim 34, wherein the polyamide comprises an additional building block selected from the group consisting of diols, polyethers having hydroxyl terminal groups, polyethers having amino terminal groups and combinations thereof.

38. The moulding material of claim 34, wherein the ω-aminocarboxylic acids and the lactams are selected from the group consisting of ∈-aminocaproic acid, 11-aminoundecanoic acid, 12-aminododecanoic acid, ∈-caprolactam, enantholactam, ω-laurolactam and combinations thereof.

39. The moulding material of claim 34, wherein the diamines are selected from the group consisting of 2,2,4- or 2,4,4-trimethylhexamethylenediamine, cyclohexyldimethyleneamine, bis(p-aminocyclohexyl)methane, m- or p-xylylenediamine, 1,4-diaminobutane, 1,6-diaminohexane, methylpentamethylenediamine, nonanediamine, methyloctamethylenediamine, 1,10-diaminodecane, 1,12-diaminododecane and cyclohexyldimethyleneamine, and the dicarboxylic acids are selected from the group consisting of succinic acid, glutaric acid, adipic acid, suberic acid, pimelic acid, suberic acid, azelaic acid, sebacic acid, dodecanedicarboxylic acid, cyclohexanedicarboxylic acid, terephthalic acid, isophthalic acid, naphthalenedicarboxylic acid and combinations thereof.

40. The moulding material of claim 26, wherein the polyamides are homopolyamides or copolyamides selected from the group consisting of polyamide 6, polyamide 46, polyamide 66, polyamide 11, polyamide 12, polyamide 1212, polyamide 1012, polyamide 610, polyamide 612, polyamide 69, polyamide 99, polyamide 9T, polyamide 12T, polyamide 10T, polyamide 12I, polyamide 12T, polyamide 12T/12, polyamide 10T/12, polyamide 12T/106, polyamide 10T/106, polyamide 6/66, polyamide 6/612, polyamide 6/66/610, polyamide 6/66/12, polyamide 6/6T, PA 6T/6, PA 6T/12, polyamide 6T/6I, polyamide 6I/6T, polyamide 6/6I, polyamide 6T/66, polyamide 6T/66/12, polyamide 12/MACMI, polyamide 66/6I/6T, polyamide MXD6/6, polyesteramides, polyetheresteramides, polyetheramides or mixtures, blends or alloys thereof.

41. The moulding material of claim 26, wherein the second moulding material is present in amounts of up to 50% by weight and a component selected from the group consisting of polyesters, polycarbonates, polyolefins, polyethylenevinyl alcohols, styrene polymers, fluoropolymers, PPS, PPO and combinations thereof is added to the moulding materials.

42. The moulding material of claim 26, wherein further additives from the group consisting of UV and heat stabilizers, antioxidants, pigments, dyes, nucleating agents, crystallization accelerators, crystallization retardants, flow improvers, lubricants, mould release agents, plasticizers, flame retardants, agents which improve the electrical conductivity and combinations thereof are added to the moulding materials.

43. The moulding material of claim 42, wherein the further additives or the fibrous filler materials are glass fibres.

44. The moulding material of claim 42, wherein the further additives are impact modifiers selected from the group consisting of the polymers based on polyolefins which may be functionalized, ethylene-propylene rubber (EPM, EPR), ethylene-propylene-diene rubbers (EPDM), acrylate rubbers, styrene-containing elastomers, SEBS, SBS, SEPS, nitrile rubbers (NBR, H-NBR), silicone rubbers, EVA, microgels combinations thereof.

45. A moulded article comprising a moulding material comprising:
(a) at least one thermoplastic polymer, selected from the group consisting of polyamides and combinations thereof;
(b) at least one nano-scale filler having a particle size of less than 500 nm in at least one dimension, the nano-scale filler in an amount of 0.5 to 15% by weight of the total weight of the moulding material,
(c) at least one fibrous filler material in amounts up to about 0 to about 65% by weight of the total weight of the moulding material, preferably about 5 to about 30% by weight, and
(d) at least one modifier in an amount from about 0 to about 25% by weight of the total weight of the moulding material, wherein the molded article has a longer retention of mechanical properties (elongation at break and/or ultimate tensile strength) and a reduced surface carbonization when the moulded article is used at a temperature above 135° C. in comparison with a moulded article comprising the same thermoplastic polymer that contains no nano-scale fillers.

46. The moulded article of claim 45, wherein the moulding material comprises a melt strength at least 30% higher than the same moulding materials which, instead of the nano-scale fillers, contain only customary mineral fillers such as, for example, amorphous silicic acid, kaolin, magnesium carbonate, mica, talc and feldspar.

47. The moulded article of claim 45, wherein the moulded article comprises a second moulding material comprising a second polyamide polymer, wherein the tensile moduli of elasticity of the two moulding materials differ by at least a factor of 1.2.

48. The moulded article of claim 47, wherein the molded article comprises an extrusion blow moulded air conducting article comprising alternating sequential rigid and flexible segments of the moulding material over its entire length.

49. The moulded article of claim 45, wherein the moulded article comprises an extrusion blow moulded air conducting air pipe for turbochargers in an automotive sector.

50. The moulded article of claim 49, wherein the conducting air pipe comprises at least one polymer layer and closed, geometrical outer structures that are a distance apart in the pipe axis direction and define a corrugation on the pipe casing in at least one radially angular region in the axial longitudinal direction in succession, the closed, geometrical outer structures being formed so that two regions of the pipe surface that are approximately opposite one another are free of corrugation extend in the longitudinal direction, the outer contours forming the corrugation having a shape selected from the group consisting of ellipses, ovals, slots and combinations thereof in the radial section.

51. The moulded article of claim 49, wherein the conducting air pipe comprises at least partly wavy regions.

52. The moulded article of claim 45, wherein the moulded article is produced by a process selected from the group consisting of extrusion blow moulding, co-extrusion blow moulding, with or without 3D-blow moulding, sequential blow moulding and combinations thereof.
